(19) United States
(12) Patent Application Publication
(10) Pub. No.: US 2005/0279223 A1
(43) Pub. Date: Dec. 22, 2005

(54) Grill accessory

(76) Inventor: James G. McPeak, Rochester, MN (US)

Correspondence Address: Dunlap & Seeger, P.A., 206 South Broadway, Suite 505, Post Office Box 549, Rochester, MN, 55903-0549, US

(21) Appl. No.: 10/870,775

(22) Filed: Jun. 18, 2004

(51) Int. Cl. A47J 37/04

(52) U.S. Cl. 99/419

(57) ABSTRACT

An accessory useful in conjunction with outdoor cookers such as gas or charcoal grills is provided having a pair of spaced feet supportable on the grill of the cooker, a pair of legs extending upwardly from each of said feet, an arm connecting the tops of the legs and one or more hangers suspendable from the arm so as to hang food attached to said hanger within the cooking chamber defined by the grate and the cover of the cooker when said hanger is suspended from said arm. In different embodiments of the invention, the legs are vertically adjustable and the arm is horizontally adjustable so as to adjust the size of the accessory according to the dimensions of the cooker with which it is used.

### BACKGROUND OF THE INVENTION

The present invention generally relates to an accessory useful in conjunction with cooking meats such as chicken and pork on outdoor cookers, such as gas and charcoal grills.

### BRIEF SUMMARY OF THE INVENTION

Outdoor cookers have long been in use for the purpose of cooking meat and other foods. Presently, the popularity of outdoor cooking is quite high. Such cookers typically utilize charcoal or gas as a source of heat. Grilling (as opposed to other methods of cooking meat such as roasting, barbecuing or smoking) is generally accomplished by directly placing the meat on a grate that is located above the heat source. Once in place, the meat may or may not be covered, depending on the desires of the person operating the cooker.

The grilling process is primarily a matter of subjecting the meat to heat over a period of time to produce the desired degree of “doneness” (i.e., rare, medium, well done). The type of meat, the cut and the size and shape of the cut are all factors that affect the amount of heat and grilling time to produce the best results. Subjecting meat to a relatively high temperature over a short period of time (searing) produces results that are desirable in the case of some meats (i.e., beef) but not others (i.e., chicken and pork). Searing produces a meat that is more thoroughly cooked on the outside and rarer on the inside. In the case of chicken and pork, however, it is generally considered better to cook the meat more evenly throughout. If chicken or pork is cooked by searing, it will either be too rare (uncooked) on the inside or overcooked on the outside and too dry.

In the case of chicken and pork, it has been determined that results are better (i.e., the meat is moist and thoroughly cooked) if the meat is cooked over a relatively lower heat for a longer period of time. This is often referred to as “slow cooking.”

There are generally two ways to control the heat that the meat being cooked is subjected to during the grilling process. One of the ways is to control the amount of heat that the cooker produces. The other is to control the distance of the meat from the heat source during cooking.

A number of variations on outdoor cookers have been developed for the purpose of controlling the heat to which the meat is subjected. In the case of gas grills, such grills have valves that control the flow of gas to the burner(s). By opening or closing the valve, the flow of gas is increased or decreased to increase or decrease the amount of heat produced by the grill. In the case of charcoal grills, air valves are provided to control the amount of air into the cooking area to control the intensity with which the charcoal is burned. The ability to control the amount of heat produced gives the cook the ability to determine the manner in which the meat is cooked.

In some cookers, mechanisms have been developed for the purpose of raising or lowering the grate upon which the meat is placed as a means to control the amount of heat that the meat is subjected to. For whatever reason, such cookers with adjustable grates have not gained wide scale acceptance in the marketplace. In the majority of the outdoor cookers in use today, the grate on which the meat is placed for cooking is generally placed at a fixed distance above the heat source.

Cooking meat on the grate of an outdoor cooker causes the meat to be subjected to a higher temperature on its underside and a cooler temperature on its upper side. It has been determined, however, that by suspending the meat above the grate in the heating chamber created between the grate and the closed cover of the cooker, the meat is subjected to a more even, uniform flow of heat which results in a juicier, more tender cooked meat. Cooking meat in this fashion should not be confused with smoking, however, wherein the meat is suspended within a smoke chamber under relatively cool temperatures. Suspending meat in the cooking chamber of outdoor cookers (as opposed to smokers) cooks the meat at relatively higher temperatures when compared to those found in the smoke chambers of smokers. In smokers, the meat is more cured by the smoke than cooked by the heat.

One object of the present invention is to provide an accessory for outdoor cookers which can be used to suspend meat and other food to be cooked on the cooker at a distance spaced above the grate within the cooking chamber defined by the grate and the cooker cover to provide for less direct, cooler and more even cooking of the meat or other food.

Another object of the invention is to provide an accessory for outdoor cookers which can be used to suspend meat and other food to be cooked on the cooker at a distance spaced above the grate within the cooking chamber defined by the grate and the cooker cover, wherein the accessory is vertically adjustable to adjust the distance that the meat or other food is spaced above the grate.

Still another object of the invention is to provide an accessory for outdoor cookers which can be used to suspend meat and other food to be cooked on the cooker at a distance spaced above the grate within the cooking chamber defined by the grate and the cooker cover, wherein the accessory is horizontally adjustable to accommodate the dimension of the particular cooker in use, to thereby increase the capacity of the accessory.

It is yet another object of the present invention to provide a variety of means to suspend the meat or other food to be cooked from the accessory to maximize the amount of meat or other food that can be cooked at any one time, according to the size and shape of the meat or other food.

To those ends, a grill accessory is provided that comprises a pair of spaced feet to rest on the grate, an upwardly extending leg attached to each of the feet and extending upwardly from the grate into the cooking chamber, an arm having ends, each of which is connected to the upper end of one of the legs, and one or more hangers capable of being suspended downwardly from the arm from which meat or other food may be suspended. In one embodiment of the invention, the legs are adjustable for the purpose of adjustably positioning the arm at different distances above the grate to thereby better control the amount of heat to which the meat or other food is subjected. In another embodiment, the arm is horizontally adjustable thereby making the accessory horizontally adjustable for the purpose of accommodating grills of differing widths.

### DESCRIPTION OF THE DRAWING

FIG. 1 is a side elevational view of a grill accessory according to the present invention in place on a gas grill.

FIG. 2 is a side elevational view of an adjustable grill accessory according to the present invention.

FIG. 3 is a top prospective view of a portion of an adjustable grill accessory according to the present invention.

FIG. 4 is a side elevational view of a nonadjustable grill accessory according to the present invention.

FIG. 5 is a side elevational view of one embodiment of a hook used in conjunction with the present invention.

FIG. 6 is a side elevational view of another embodiment of a hook used in conjunction with the present invention.

FIG. 7 is a side elevational view of a portion of another embodiment of the foot and leg assembly according to the present invention.

### DETAILED DESCRIPTION OF THE PREFERRED EMBODIMENT

Referring to the drawing, wherein like numerals represent like elements throughout the several views, there is shown a grill accessory generally designated by the numeral 10. The accessory 10 is designed for use in conjunction with outdoor cookers, designated 11. Although described with reference to a gas grill 11, it will be understood that the accessory 10 has equal utility with respect to charcoal grills and other outdoor cookers.

The typical gas grill 11 generally consists of a stand (not shown), a body 12, a heating element (not shown) such as a gas burner, a heat retaining medium (not shown) such as lava rocks or metal bars, a grate 13 located above the heating elements and a cover 14 which is operable between an open position and a closed position. In conventional use, the heating element is lit and generates heat to increase the temperature of the heat retaining medium. Once the desired temperature is reached, the food to be cooked is placed on the grate 13 where the heat from the heat retaining medium cooks the food. The closer the grate 13 is to the heat retaining medium, the more heat the food will be subjected to. Depending on the type of cooking desired, the cover 14 may be placed in the closed position to facilitate the cooking of the food. A space is defined between the grate 13 and the cover 14, the exact dimensions of which are determined by the width of the body 12 and the height of the cover 14.

The accessory 10 of the present invention generally comprises a pair of angled feet 20, a leg 21 extending generally upwardly of each of the feet 20, an arm 22 extending between the tops of each of the legs 21, and a plurality of hangers 23 for hanging the food to be cooked from the arm 22. All elements of the accessory 10 are preferably formed of metal (such as stainless steel) and are either integrally formed or attached by welding.

The feet 20 have first and second portions 24, 25 extending at an angle (preferably 120 degrees) to one another to facilitate the placement of the accessory 10 on the grate 13 so as to prevent the feet 20 from slipping or falling between the bars of the grate 13. The lower end of each leg 21 is preferably attached to the associated foot 20 at the place where the first and second portions 24, 25 of the foot 20 are connected for stability and extends generally upwardly from the plane of the grate 13 when the accessory 10 is in place on the grate 13.

The tops of each leg 21 are each attached (integrally, by welding or by some other mechanism) to one end of the arm 22. The height of the legs 21 is such that the food to be cooked can be suspended from the arm 22 and that the accessory 10 will fit within the cooker 11 when the cover 14 is closed. The width of the arm 22 is also such that the accessory 10 will fit on the grate 13.

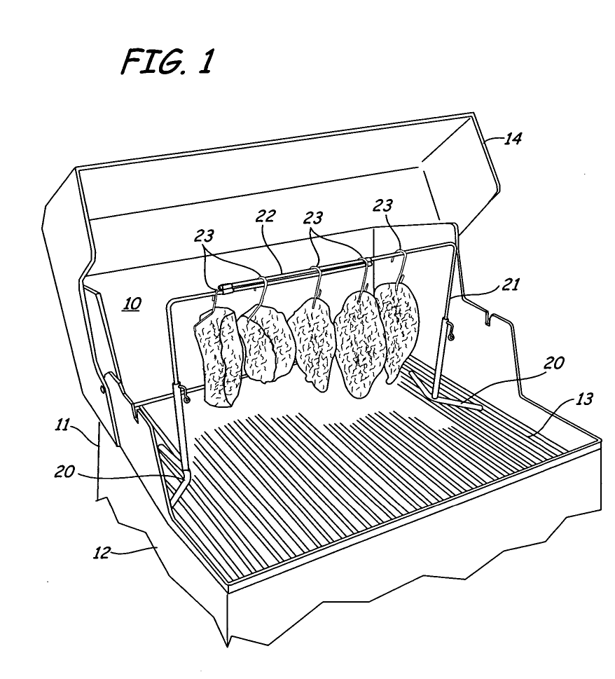

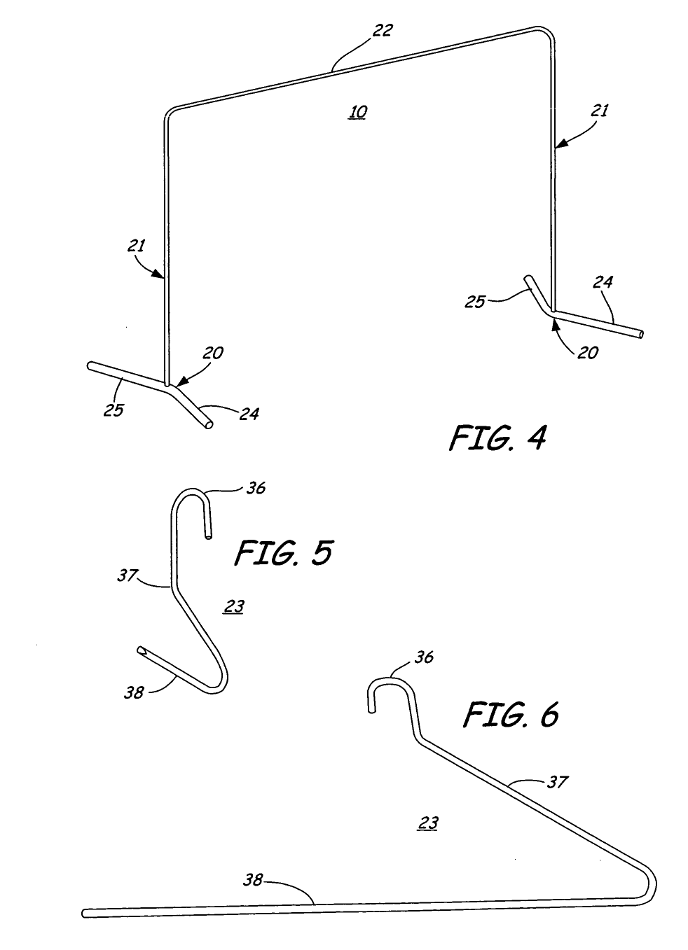

The accessory 10 may be either fixed in dimension or the legs 21 and arm 22 may be adjustable to permit the size of the accessory 10 to be adjusted according to the dimensions of the particular cooker 11 with which it is being used. FIG. 4 generally shows a fixed dimension accessory 10 as described above. FIGS. 1, 2 and 3 generally show adjustable accessories 10.

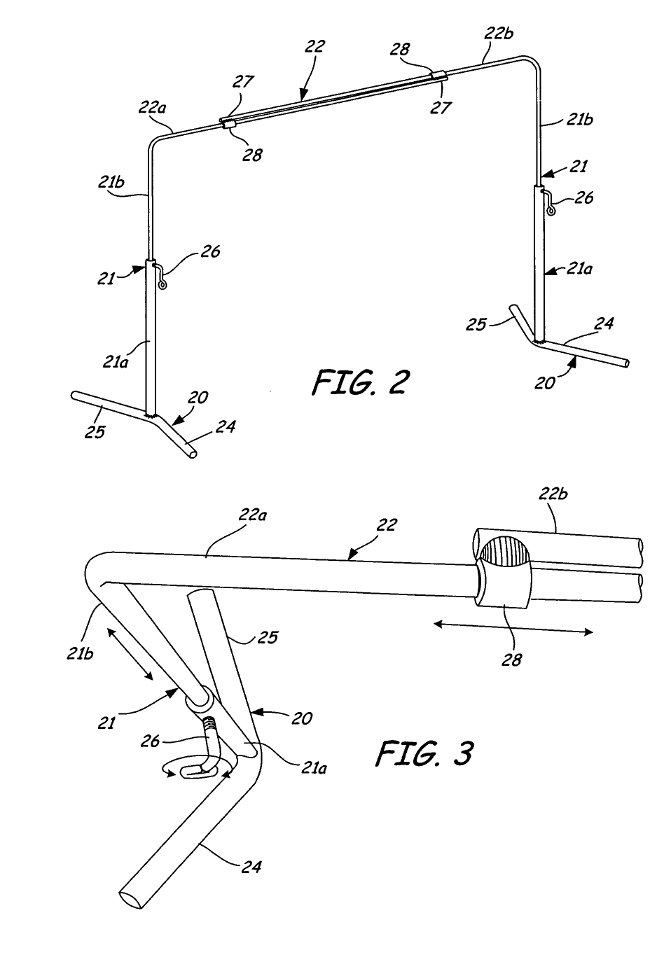

Referring to FIG. 2, each leg 21 of the accessory 10 has a lower portion 21a and an upper portion 21b. Upper portions 21b are rods and lower portions 21a are tubular members sized to slideably receive the corresponding upper portion 21b therein. The height of the legs 21 are adjusted by adjusting the degree to which the upper portion 21b of each leg 21 extends into each corresponding lower portion 21a. A set screw 26 is provided extending into the lower portion 21a which may be tightened to engage the corresponding upper portion 21b so as to limit the degree by which the upper portion 21b extends into the lower portion 21a, thereby establishing the desired height of leg 21.

Still referring to FIG. 2, the arm 22 has a first portion 22a and a second portion 22b, wherein each portion 22a, 22b is provided with a slip rod assembly 27 on its inner end. As shown, the slip rod assembly 27 comprises a tubular or looped member 28 carried on the inner end of each arm portion 22a, 22b, the member 28 of each arm portion 22a, 22b being sized to slideably receive the other arm portion 22b, 22a therethrough. The width of the arm 22 is adjusted by adjusting the degree to which the arm portions 22a, 22b overlap one another.

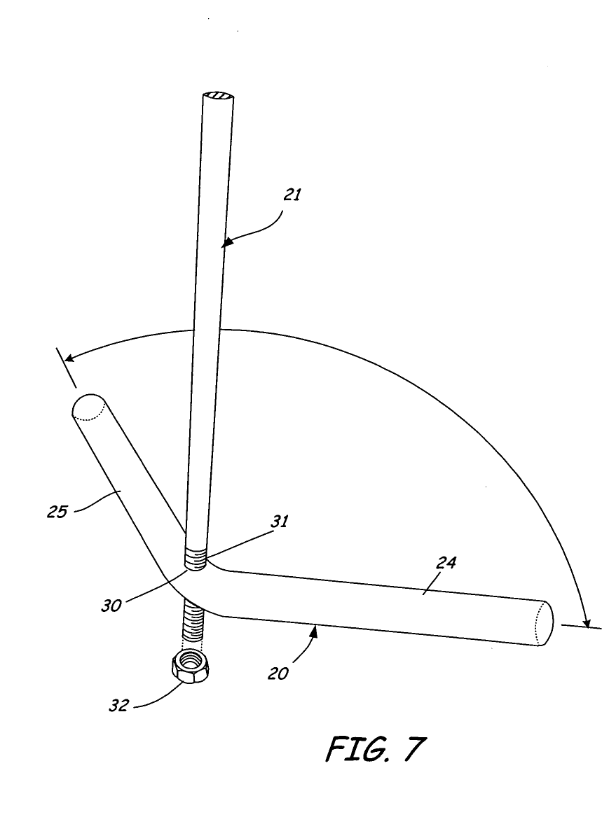

A second embodiment of an adjustable leg 21 is shown in FIG. 7. In this embodiment, the foot 20 has a female threaded bore 30 drilled through the point of connection between the foot portions 20. The bore 30 extends through foot 20 perpendicularly to the plane of the foot 20. A male thread 31 sized to be received within threaded bore 30 is formed on the lower end of each leg 21. The male thread 31 extends upwardly on the lower end of leg 21 a sufficient distance to accommodate the desired amount of vertical adjustment, generally on the order of 3 to 4 inches. The height of legs 21 are adjusted by adjusting the extent to which the lower threaded portion of each leg 21 is screwed into the threaded bore 30 in each foot 20. Once the desired height is obtained, a hex nut 32 is provided to engage the portion of male thread 31 extending beneath foot 20 and tightened against foot 20 to secure the leg 21 in the desired relation to the foot 20. When placed on the grate 13, the portions of legs 21 extending beneath the feet 20 extend downwardly into the open areas of the grate 13.

The accessory 10 includes a plurality of hangers 23 designed to hang the food to be cooked from the arm 22 so as to suspend the food above the grate 13 in the area between the grate 13 and the cover 14 of the cooker 11. Hangers 23 generally have an upper hook portion 36 that is curved back against itself to engage the arm 22, a downwardly and outwardly extending mid portion 37 and a lower portion 38 angled inwardly and upwardly with respect to the mid portion 37. The food to be cooked is suspended from the hanger 23 by impaling the food on the lower portion 38 and hanging the upper hook portion 36 from the arm 22. The length and configuration of the mid portion 37 and the lower portion 38 may be varied to accommodate the size of the food to be hung from the hanger 23 such that the food is suspended above the grate 13 and beneath the arm 22. The thicker the food is, the longer the mid portion 37 and lower portion 38 should be.

Two different embodiments are shown for the hanger 23 in FIGS. 5 and 6. In one embodiment shown in FIG. 5, the upper hook portion 36 extends in a plane perpendicularly to the plane of the mid portion 37 and the lower portion 38. This configuration causes the lower portion 38 to extend generally beneath and along the same direction as arm 22. This embodiment is most useful in conjunction with foods that are thinner than they are wide so that when the lower portion 38 is impaled through the width of the food, the wide portion of the food extends generally perpendicularly to the arm 22 to maximize the amount of food that can be cooked at any one time. In the other embodiment shown in FIG. 6, the upper hook portion 36, the mid portion 37 and the lower portion 38 all extend in the same plane. This configuration causes the lower portion 38 to extend beneath and generally perpendicularly to the arm 22. This embodiment is most useful in conjunction with foods where it is preferable to impale the lower portion 38 through the wider portion of the food, again to maximize the amount of food that can be cooked at any one time. Which of the different hangers 23 are used is a choice to be made by the operator of the cooker 11 depending on the configuration of the food being cooked.

In operation, the cooker 11 is started by activating the heating element to heat the heat retaining medium. In the case of an adjustable accessory 10, the accessory 10 is adjusted to the desired dimensions, if necessary. The food is hung on the hangers 23 and suspended from the arm 22. Once the desired temperature has been reached within the cooking chamber, the accessory 10 with the food hung from the hangers 23 is placed on the grate 13 and the cover 14 is closed. The temperature within the cooking chamber is monitored and once the food has reached the desired degree of doneness, the food and the accessory 10 are removed from the cooker 11.

While I have described the preferred embodiments of my invention, it will be evident to those skilled in the art that other embodiments may be possible within the scope of my invention.

1. An accessory for use in conjunction with an outdoor cooker having a cooking chamber defined by a grate and a cover, comprising:
(a) a pair of spaced feet supportable upon the grate;
(b) a pair of legs, one extending upwardly from each of said feet;
(c) an arm connecting the tops of each of said legs; and
(d) one or more hangers suspendable from said arm to suspend food items within the cooking chamber of the cooker.

2. An accessory for use in conjunction with an outdoor cooker having a cooking chamber defined by a grate and a cover, comprising:
(a) a pair of spaced feet supportable upon the grate, each of said feet having a first foot portion and a second foot portion extending at an angle to one another;
(b) a pair of legs, one of said legs extending upwardly from each of said feet;
(c) an arm extending between the tops of said legs oppositely of said feet; and
(d) one or more hangers suspendable from said arm to suspend food items within the cooking chamber of said cooker.

3. An accessory according to claim 2, wherein each of said legs comprises means for selectively adjusting the length of said leg.

4. An accessory according to claim 2, wherein each of said legs comprises a tubular lower portion and an upper portion, said upper portion being sized to be slideably received within said lower portion, said lower portion having a threaded bore defined therein, and a set screw operable within said threaded bore.

5. An accessory according to claim 2, wherein each of said feet have a threaded bore defined therein at the point of connection of said first foot portion and said second foot portion and wherein said legs have a threaded lower portion sized to operate within said threaded bores in said feet, said accessory further comprising a nut sized to engage said threaded lower portion of said legs.

6. An accessory according to claim 2, wherein said arm comprises means for selectively adjusting the length of said arm.

7. An accessory according to claim 2, wherein said arm comprises a first arm portion and a second arm portion, said first arm portion and said second arm portion being adjustably positionable with respect to one another.

8. An accessory according to claim 2, wherein said arm comprises a first arm portion and a second arm portion, each of said portions being attached at one end to the top of one of said legs and having a tubular member attached to the other end, said tubular member being sized to slideably receive the other of said arm portion therein.

9. An accessory according to claim 2, wherein each of said hangers comprises a top hook portion, a downwardly and outwardly extending mid hook portion and an inwardly extending lower hook portion angled with respect to said mid hook portion.

10. An accessory for use in conjunction with an outdoor cooker having a cooking chamber defined by a grate and a cover, comprising:
(a) a pair of feet supportable upon the grate of an outdoor cooker;
(b) a pair of legs, one of said legs extending upwardly from each of said feet, each of said legs comprising a tubular lower leg portion and an upper leg portion sized to be received within said lower leg portion, said lower leg portion having a threaded bore extending therethrough, and a set screw operable with said threaded bore;
(c) an arm being attached at each end to one of said legs; and
(d) one or more hangers suspendable from said arm.

11. An accessory for use in conjunction with an outdoor cooker having a cooking chamber defined by a grate and a cover, comprising:
(a) a pair of angled feet supportable upon the grate of an outdoor cooker, each of said feet having a first foot portion and a second foot portion angled with respect to said first foot portion, each of said foot portions defining a threaded bore extending therethrough;
(b) a pair of legs, each of said legs having a threaded lower portion operable within said threaded bore of one of said feet;
(c) a pair of threaded nuts, each of said nuts being sized to be operable on said threaded lower portion of one of said legs to secure said leg to one of said feet;
(d) an arm being attached at each end to one of said legs; and
(e) one or more hangers suspendable from said arm.

12. An accessory for use in conjunction with an outdoor cooker having a cooking chamber defined by a grate and a cover, comprising:
(a) a pair of angled feet supportable upon the grate of an outdoor cooker;
(b) a pair of legs, each of said legs being attached to one of said feet and extending upwardly therefrom; and
(c) an arm being attached at each end to one of said legs, said arm comprising a first arm portion and a second arm portion, each of said arm portion defining an annular member opposite of said leg, said annular member being sized to slideably receive the other of said arm portions therethrough.
